(19) United States
(12) Patent Application Publication
(10) Pub. No.: US 2009/0285563 A1
(43) Pub. Date: Nov. 19, 2009

(54) REPRODUCTION DEVICE, PRODUCTION METHOD, PROGRAM, AND STORAGE MEDIUM

(75) Inventors: Yasuhiro Endo, Kanagawa (JP); Kazuhiro Onizuka, Kanagawa (JP)

Correspondence Address: SHEEHAN PHINNEY BASS & GREEN, PA;c/o PETER NIEVES, 1000 ELM STREET, MANCHESTER, NH, 03105-3701, US

(73) Assignee: D&M Holdings Inc., Kanagawa (JP)

(21) Appl. No.: 12/304,328

(22) PCT Filed: Feb. 5, 2007
(86) PCT No.: PCT/JP2007/051899

§ 371 Date: Dec. 11, 2008

(30) Foreign Application Priority Data
Jun. 16, 2006 (JP) 2006-167578

(51) Int. Cl. H04N 5/91

(52) U.S. Cl. 386/96

(57) ABSTRACT

A reproduction device includes:
a reproduction unit (16) for reproducing an audio signal and a video signal stream correlated to each other;
an audio buffer memory (18) which stores the audio signal reproduced by the reproduction unit (16) and from which the stored audio signal is read out;
a video buffer memory (20) which stores the video signal reproduced by the reproduction unit (16) and from which the stored video signal is read out;
an operation detection unit (40) for detecting an input operation of an operator concerning the read out of the audio signal or the video signal from the audio buffer memory (18) or the video buffer memory (20); and
a system CPU (12) which performs control to read out one of the audio signal and the video signal from the audio buffer memory (18) or the video buffer memory (20) at a predetermined speed and order and to read out the other signal at the speed and the order based on the input operation detected by the operation detection unit (40). The system CPU (12) monitors whether the difference between the current reproduction points of the audio signal and the video signal exceeds a predetermined value.

### TECHNICAL FIELD

The present invention relates to a technique on a reproduction apparatus that can asynchronously reproduce an audio signal and a video signal recorded synchronously with each other.

### BACKGROUND ART

As digital techniques develop, it becomes common to use a CD player that can perform special reproduction of a Compact Disc (CD) in a similar way to special reproduction using an analog record (such as so-called scratch reproduction). Such a CD player is used favorably by a Disc Jockey (DJ) at a nightclub, a home party, or the like.

Such a CD player stores in a memory an audio signal reproduced from a CD or the like. This CD player is provided with a jog dial having a form like an analog record, so that the speed and order of reading audio signals stored in the memory are controlled according to the rotating direction and speed of the jog dial. By rotating operation of the jog dial similarly to an analog record, an operator such as a DJ can produce sound effects such as friction sounds similar to those in the case where an analog record player is used.

Further, recently a person can readily obtain not only digital audio contents but also digital video contents, for example, with wide spread use of a Digital Versatile Disc (DVD) following the development of the compression technique. Under such circumstances, has been developed a signal processing apparatus that can perform special reproduce of both digital audio signal and digital video signal by operation similar to that in the above-mentioned CD player (See Japanese Unexamined Patent Application Laid-Open No. 2005-108294). A person who operates an audio signal and a video signal by using such a reproduction apparatus in, particularly, a nightclub or a home party is called a Visual Jockey or Video Jockey (VJ).

Such a reproduction apparatus stores a video signal and an audio signal in respective buffer memories, and can asynchronously adjust a reproduction speed of at least one of the signals. By using selection buttons, an operator determines which of the video signal and the audio signal should be adjusted in its reproduction speed or the like.

### DISCLOSURE OF THE INVENTION

Asynchronous reproduction of a video signal and an audio signal means that reproduction positions of those signals are made to be different from each other. For example, in the case where scratch reproduction is performed only with respect to the video signal while the audio signal is reproduced ordinarily, the reproduction of the video signal is retarded or expedited in comparison with the reproduction of the audio signal according to the time code. In other words, for the audio signal, a current reproduction point of data stored in buffer memories is a time point conforming to the time code, while a current reproduction point for the video signal is different from that time point.

For a VJ for example, it is favorable that a reproduction position of each signal can be varied largely, since the degree of freedom of staging becomes higher.

However, it requires high-capacity buffer memories, a high-speed read drive and the like to ensure large variability of reproduction position of each signal. Further, to realize instantaneous transition from asynchronous reproduction to synchronous reproduction, the buffer memory for one signal must store not only the reproduction position of the signal in question but also data preceding and following the reproduction position of the other signal, requiring a high capacity of buffer memory. Thus, to realize complete freedom of asynchronous reproduction, a reproduction apparatus costs very much.

Considering the above situation, an object of the present invention is to provide a reproduction apparatus, a reproduction method, a program, and a storage medium that enable low-cost asynchronous reproduction of audio and video signals while ensuring free rendering by an operator to the largest extent possible.

To achieve the above object, a first mode of the present invention provides a reproduction apparatus comprising: a reproduction part for reproducing a stream of an audio signal and a video signal that are related to each other; an audio buffer memory for storing the audio signal reproduced by the reproduction part, so that the stored audio signal is read from the audio buffer memory; a video buffer memory for storing the video signal reproduced by the reproduction part, so that the stored video signal is read from the video buffer memory; an operation detection part for detecting an input operation by an operator concerning read of the audio signal or the video signal from the audio buffer memory or the video buffer memory; and a control part for performing control such that one of the audio signal and the video signal is read at a certain speed and in certain order from the audio buffer memory or the video buffer memory and the other signal is read at a speed and in order both corresponding to the input operation detected by the operation detection part, while the control part monitors whether a difference between respective current reproduction points of the audio and video signals becomes more than or equal to a prescribed value.

In the above configuration, it is favorable that, when the difference between the current reproduction points becomes more than or equal to the prescribed value, the control part gives a warning to that effect to the operator for a prescribed time.

Further, the control part may make the current reproduction points of the audio and video signals coincide with each other after an elapse of the prescribed time for the warning.

To achieve the above object, a second mode of the present invention provides a reproduction method comprising: a reproduction step, in which a stream of an audio signal and a video signal that are related to each other is reproduced; a audio buffering step, in which the audio signal reproduced in the reproduction step is stored in an audio buffer memory; a video buffering step, in which the video signal reproduced in the reproduction step is stored in a video buffer memory; an audio read step, in which the audio signal stored in the audio buffer memory is read; a video read step, in which the video signal stored in the video buffer memory is read; and an operation detection step, in which an input operation by an operator concerning read of the audio signal or the video signal from the audio buffer memory or the video buffer memory; and a control step, in which one of the audio signal and the video signal is read at a certain speed and in certain order from the audio buffer memory or the video buffer memory, and the other signal is read at a speed and in order both corresponding to the input operation detected in the operation detection step, and further it is monitored whether a difference between respective current reproduction points of the audio and video signals becomes more than or equal to a prescribed value.

It is favorable that the above method further comprises a step, in which when the difference between the current reproduction points becomes more than or equal to the prescribed value, a warning to that effect is given to the operator for a prescribed time.

Further, the above method may further comprise a step, in which the current reproduction points of the audio and video signals are made to coincide with each other after an elapse of the prescribed time for the warning.

To achieve the above object, a third mode of the present invention provides a program for making a computer execute: a reproduction procedure, in which a stream of an audio signal and a video signal that are related to each other is reproduced; a audio buffering procedure, in which the audio signal reproduced in the reproduction procedure is stored in an audio buffer memory; a video buffering procedure, in which the video signal reproduced in the reproduction procedure is stored in a video buffer memory; an audio read procedure, in which the audio signal stored in the audio buffer memory is read; a video read procedure, in which the video signal stored in the video buffer memory is read; an operation detection procedure, in which an input operation by an operator concerning read of the audio signal or the video signal from the audio buffer memory or the video buffer memory; and a control procedure, in which one of the audio signal and the video signal is read at a certain speed and in certain order from the audio buffer memory or the video buffer memory, and the other signal is read at a speed and in order both corresponding to the input operation detected in the operation detection procedure, and further the control procedure includes a procedure in which it is monitored whether a difference between respective current reproduction points of the audio and video signals becomes more than or equal to a prescribed value.

It is favorable that the above program further comprises a procedure, in which when the difference between the current reproduction points becomes more than or equal to the prescribed value, a warning to that effect is given to the operator for a prescribed time.

Further, the above program may further comprise a procedure, in which the current reproduction points of the audio and video signals are made to coincide with each other after an elapse of the prescribed time for the warning.

The above program may be recorded in a computer-readable storage medium.

### BRIEF DESCRIPTION OF DRAWINGS

FIG. 1 is a block diagram showing a configuration of a reproduction apparatus according to an embodiment of the present invention;

FIG. 2 is a diagram showing states of buffer memories in an embodiment of the present invention;

FIG. 3 is a flowchart showing operation of a reproduction apparatus according to an embodiment of the present invention; and

FIG. 4 is a diagram showing a state of buffer memories in another embodiment of the present invention.

### BEST MODE FOR CARRYING OUT THE INVENTION

Now, an embodiment of the present invention will be described in detail referring to the drawings. The embodiment shown in the following is only an example, and does not intend to restrict the present invention.

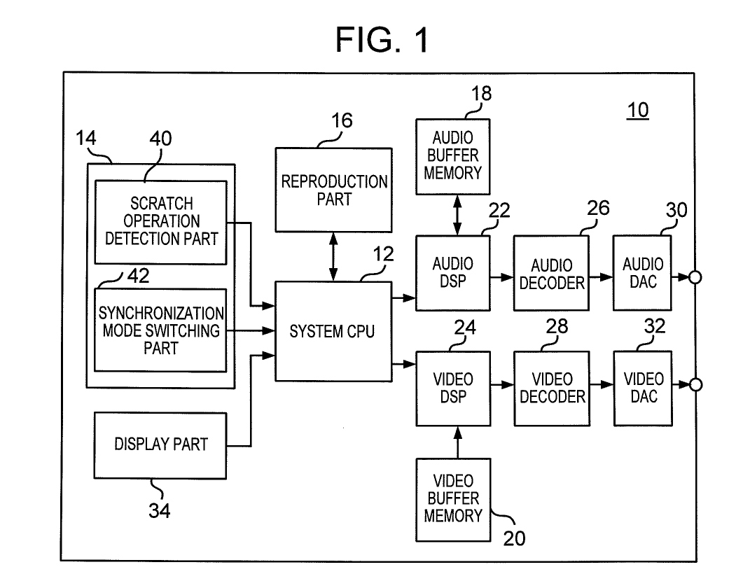

FIG. 1 shows a configuration of an output apparatus of an embodiment of the present invention. A reproduction apparatus 10 shown in FIG. 1 comprises a system Central Processing Unit (CPU) 12, an operation part 14, a reproduction part 16, an audio buffer memory 18, a video buffer memory 20, an audio Digital Signal Processor (DSP) 22, a video DSP 24, an audio decoder 26, a video decoder 28, an audio Digital-to-Analog Converter (DAC) 30, a video DAC 32, and a display part 34.

The system CPU 12 controls the below-described operation of the reproduction apparatus 10 generally.

The reproduction part 16 includes a read drive for a storage medium, and reads and reproduces digital data stored in a storage medium such as a CD, a DVD or the like. The reproduction part 16 may reproduce digital data sent from an external storage unit/reproduction unit, or analog data converted to digital data. An audio signal and a video signal outputted from the reproduction part 16 are components of a same content, and related to each other by a same time code.

The audio buffer memory 18 stores a digital audio signal separated from a composite data stream outputted from the reproduction part 16.

The video buffer memory 20 stores a digital video signal separated from a composite data stream outputted from the reproduction part 16.

The audio buffer memory 18 and the video buffer memory 20 are each formed for example as a ring buffer, which is arranged such that the top memory address is connected with the bottom memory address. In the present embodiment, the audio buffer memory 18 and the video buffer memory 20 have capacities that can store an audio signal and a video signal of the same time length (for example, 30 seconds) respectively.

The audio DSP 22 manages a memory address of the audio buffer memory 18. Further, the audio DSP 22 reads out an audio signal stored in the audio buffer memory 18, in address order and at a speed both designated by the system CPU 12.

The video DSP 24 manages a memory address of the video buffer memory 20. Further, the video DSP 24 reads out a video signal stored in the video buffer memory 20, in address order and at a speed both designated by the system CPU 12. For example, the video DSP 24 performs reproduction frame by frame at the time of high speed reproduction, and a same frame repeatedly at the time of low speed reproduction.

The audio decoder 26 decodes a digital audio signal read by the audio DSP 22 from the audio buffer memory 18.

The video decoder 28 decodes a digital video signal read by the video DSP 24 from the video buffer memory 20.

The audio DAC 30 converts the decoded digital audio signal into an analog audio signal, and outputs the analog audio signal to an external device such as a speaker, a mixer, or the like. If the external device can receive a digital input, output may be given in a prescribed digital format.

The video DAC 32 converts the decoded digital video signal into an analog video signal, and outputs the analog video signal to a monitor, a mixer or the like. If the external device can receive a digital input, output may be given in a prescribed digital format.

The display part 34 comprises a liquid crystal display or the like, and displays an image, attribute information, a reproduction state and the like of data under reproduction.

The operation part 14 has a reproduction start button, a reproduction stop button and the like, and receives operator's input concerning reproduction operation or the like.

Further, the operation part 14 comprises a scratch operation detection part 40 and a synchronization mode switching part 42.

The scratch operation detection part 40 detects operation input by the operator concerning reproduction speed and reproducing order of audio signals and/or video signals. In the present embodiment, operation of reproducing these audio signals or video signals by changing reproduction speed and reproducing order is generically called “scratch operation”. “Scratch operation” includes all operations in a state (the below-described scratch mode) that allows reproduction in different order and at different speed from ordinary reproduction.

The scratch operation detection part 40 comprises, for example, an operation disk (not shown) provided with a plurality of slits arranged at nearly regular intervals in the outer peripheral portion and an optical sensor (not shown) having a pair of a light emitting element and a light receiving element. The operation disk is formed similarly to an analog record, and mounted on a turntable (not shown) so that it is rotated at a prescribed reproduction speed such as the reproduction speed of an analog record. Based on pulse signals generated by the optical sensor when light between the light emitting element and the light receiving element passes through slits, the system CPU 12 discriminates a rotation state (rotating speed and direction) of the operation disk to detect a state of scratch operation by the operator. The scratch operation detection part 40 may comprise a rotary encoder and the like to detect rotating operation and the like.

Based on input detected by the scratch operation detection part 40, the system CPU 12 controls the audio DSP 22 and/or the video DSP 24 in reading of an audio signal and/or a video signal from the audio buffer memory 18 and the video buffer memory 20. By this arrangement, the operator can perform scratch reproduction similar to the case using an analog record, by rotating operation of the disk part.

The synchronization mode switching part 42 receives an instruction to switch modes between a synchronous scratch mode, an audio-only scratch mode and a video-only scratch mode.

When the synchronous scratch mode is selected, an audio signal and a video signal are reproduced synchronously according to operation detected by the scratch operation detection part 40.

When the video-only scratch mode or the audio-only scratch mode is selected, an audio signal and a video signal are reproduced asynchronously. That is to say, one of an audio signal and a video signal is reproduced according to operation detected by the scratch operation detection part 40, and the other is reproduced ordinarily in the order according to the time code and at predetermined Beat Per Minute (BPM).

When the scratch operation detection part 40 does not detect scratch operation at the time of asynchronous reproduction, reproduction is performed according to the speed and order that are set in conformity with the time code.

In the following, will be described adjustment of current reproduction points of an audio signal and a video signal in the course of asynchronous reproduction of the present embodiment. Here, “current reproduction point” means a time point (in the time code) at which reproduction (reading) is actually performed in the audio buffer memory 18 or the video buffer memory 20. A current reproduction point goes forward, stays, or goes back as reproduction according to operator's reproduction operation proceeds.

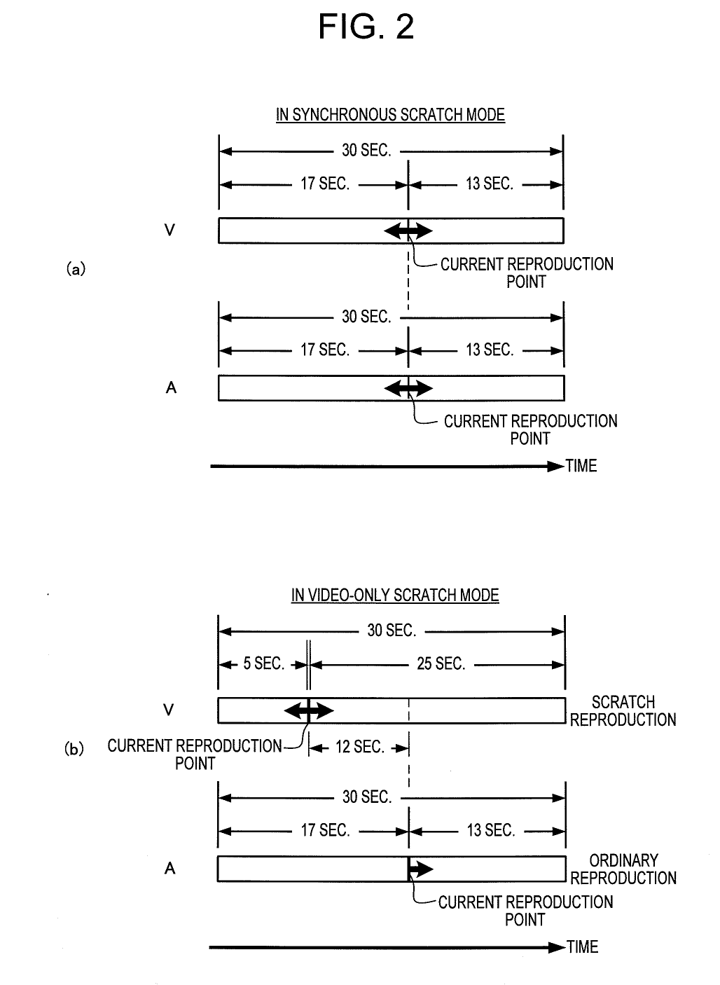

In the present embodiment, as shown in FIG. 2(a), each of the audio buffer memory 18 and the video buffer memory 20 keeps prescribed data quantities for the future and the past with respect to the current reproduction point according to the time code. That is to say, buffer data of the audio buffer memory 18 and the video buffer memory 20 are updated regularly (for example, at intervals of 10 milliseconds) by data of a stream from the reproduction part 16, so as to maintain given quantities of data before and after the current reproduction point. In the example shown in FIG. 2(a), each of the audio buffer memory 18 and the video buffer memory 20 holds data of 30 seconds, i.e. data of 17 seconds for the past from the current reproduction point according to the time code and data of 13 seconds for the future from the current reproduction point.

In the course of reproduction of the synchronous scratch mode, the current reproduction point of the audio signal (A in the figure) and the current reproduction point of the video signal (V in the figure) coincide with each other. Further, not only at the time of ordinary reproduction but also at the time of scratch reproduction, the buffer data are updated as reproduction of both signals proceeds, to secure the prescribed quantities of data for the future and the past. Thus, even when fast-forward reproduction, reverse-reproduction or the like is instructed by scratch operation, it is possible to respond to the instruction because of the buffers of sufficient data quantities.

In the course of the asynchronous reproduction (the audio-only scratch mode or the video-only scratch mode), buffer data of both the audio buffer memory 18 and the video buffer memory 20 are updated as reproduction at the current reproduction point of one signal that is ordinarily reproduced proceeds. For example, in the example shown in FIG. 2(b), the audio signal (A) is reproduced ordinarily in the video-only scratch mode, while the scratch reproduction is performed with respect to the video signal (V). Thus, as for the audio signal in the example shown in the figure, the prescribed quantities of data before and after the current reproduction point are always kept.

On the other hand, as for the signal reproduced by the scratch reproduction (i.e. the video signal V in the example shown in FIG. 2(b)), the buffer data is updated as the reproduction of the other signal (the audio signal) proceeds. As a result, it is possible that the current reproduction point of the signal under scratch reproduction is largely different from the current reproduction point of the other signal. In that case, it is possible that sufficient data are not secured before or after the current reproduction point of the signal under scratch reproduction. For example, in the case where the current reproduction point of the video signal is delayed for 10 seconds from the current reproduction point of the audio signal as shown in FIG. 2(b), data of only 5 seconds are kept before the current reproduction point (i.e. in the direction of reverse reproduction) of the video signal. Thus, in the case where the current scratch reproduction (i.e. the reverse reproduction) is continued, it is probable that the signal under scratch reproduction can not be reproduced owing to a shortage of the buffer data.

In the present embodiment, to avoid such a situation, the system CPU 12 monitors the difference between the current reproduction points of the audio signal and the video signal in the course of reproduction. In the course of asynchronous reproduction, the system CPU 12 monitors the difference between the current reproduction point of the signal under scratch reproduction and the current reproduction point of the other signal under ordinary reproduction, for example on the basis of the time code. The system CPU 12 monitors whether the difference between the respective current reproduction points of the signals becomes more than or equal to a prescribed threshold, for example 10 seconds.

Here, favorably, the threshold of the difference between the current reproduction points of the audio and video signals is set on the basis of the capacities of the audio buffer memory 18 and the video buffer memory 20. In the case where the buffer memories of larger capacities are used, it is possible to secure larger threshold of the difference between the current reproduction points of those signals. However, the larger the capacity is, the higher the price of a memory is. Thus, the capacity of a usable buffer memory is restricted by cost.

When the monitored difference between the current reproduction points becomes more than or equal to the prescribed threshold, the system CPU 12 makes the display part 34 display a warning to that effect. This warning display is given as a text display or a blink/color change of a screen, for example. By the warning, the operator knows that the current reproduction points of the video and audio signals are largely apart from each other and thus the buffer capacity for one signal may become deficient in the reproduction direction or the reverse direction. The warning is displayed for a prescribed time period (for example, for 4 seconds) so that the operator can become aware of and cope with the warning. The warning display is given for example as “Warning->”. Thus, the warning message is displayed together with indication of the regular or reverse direction in which the operator should reproduce (or should not reproduce) the signal under scratch reproduction.

When the warning is displayed, the operator makes operation such that the current reproduction points of the audio and video signals become close to each other in accordance with the currently-performed staging of reproduction. For example, in the example shown in FIG. 2(b), the operator performs forward reproduction (fast-forward reproduction) of the video signal at a speed higher than the reproduction speed of the audio signal in a suitable manner for the currently-performed staging, to reduce the difference between the current reproduction points of the signals. If it is suitable for the staging, the synchronization mode switching part 42 may be operated to switch the mode from the asynchronous reproduction (the video-only scratch mode) to the synchronous reproduction (the synchronous scratch mode).

The system CPU 12 judges whether the difference between the current reproduction points of the video signal and the audio signal is still more than or equal to the prescribed value after a prescribed time period from the warning display. When it is judged that the difference between the current reproduction periods of both signals is more than or equal to the prescribed value after an elapse of the prescribed time, the system CPU 12 makes the current reproduction point of the signal under scratch reproduction coincide (i.e. be synchronized) with the current reproduction point of the other signal under ordinary reproduction. In other words, in the example shown in FIG. 2(b), the state shown in the figure is made to transition to the state shown in FIG. 2(a).

Thus, in the present embodiment, in the case where the difference between the current reproduction points of both signals is more than or equal to the prescribed value after an elapse of the prescribed time while the operator does not notice the warning display or leaves the warning display as it is, the signal under scratch reproduction is forcedly synchronized with the other signal under ordinary reproduction. As for the signal under ordinary reproduction, sufficient data buffer capacities are secured before and after the current reproduction point. Thus, when the difference between the current reproduction points becomes larger and it is possible that the buffer quantity of the signal under scratch reproduction becomes deficient, then the buffer quantity of the signal under scratch reproduction can be sufficiently secured by forcedly synchronizing the signal under scratch reproduction with the signal under ordinary reproduction.

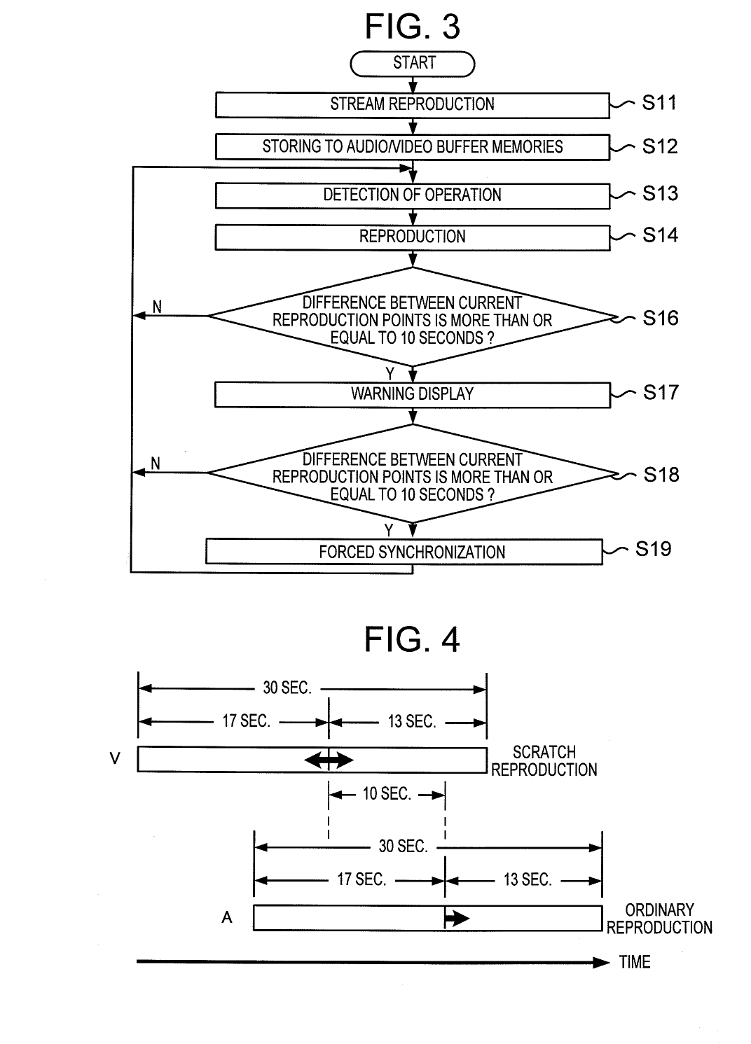

In the following, operation of the reproduction apparatus of the present embodiment in the course of reproduction will be described. FIG. 3 is a flowchart showing reproduction operation. The flowchart shown in the figure is an example. Any flow may be employed as far as a similar result can be obtained.

In the course of the reproduction operation, the system CPU 12 controls the reproduction part 16 to reproduce a composite stream of the audio and video signals (Step S11).

The system CPU 12 controls the audio DSP 22 and the video DSP 24 to separate the audio signal and the video signal in the stream and to store the audio signal and the video signal in the audio buffer memory 18 and the video buffer memory 20 respectively (Step S12). Here, the audio signal and the video signal extracted from the stream are respective pieces of data corresponding to the same time code.

Based on the detected signal from the scratch detection part 40, the system CPU 12 judges the sate of scratch operation (Step S13). When scratch operation is detected, the audio signal and the video signal are read from the audio buffer memory 18 and the video buffer memory 20 at the designated speeds and in the designated orders. As for the video signal, frame processing is performed according to the reproduction speed.

In the synchronous scratch mode, the audio signal and the video signal are read synchronously. In the video-only scratch mode, only the video signal is subjected to the scratch reproduction, while the audio signal is ordinarily reproduced. In the audio-only scratch mode, only the audio signal is subjected to the scratch reproduction, while the video signal is ordinarily reproduced. When scratch operation is not detected, the audio signal and the video signal are read at the ordinary speed and reproduced (Step S14).

In the course of reproduction, the system CPU 12 monitors whether the difference between the current reproduction points for the audio buffer memory 18 and the video buffer memory 20 is more than or equal to the prescribed value, for example 10 seconds (Step S16).

When the difference between the current reproduction points is less than the prescribed value (Step S16: NO), reproduction is performed according to operation by the operator (Step S13). In other words, in this state, within the limited buffer capacities, buffer data of both the audio and video signals are secured sufficiently for enabling scratch reproduction conforming to the intention of the operator.

When the difference between the current reproduction points is more than or equal to the prescribed value (Step S16: YES), the system CPU 12 displays the warning to that effect and the recommended reproduction direction (the regular direction or the reverse direction) for a prescribed time, for example 4 seconds (Step S17). When the operator sees the warning display, the operator knows that the buffer quantity for the signal under scratch reproduction may become deficient and it is better to perform scratch reproduction in the regular or reverse direction. At that time, the operator performs scratch reproduction for eliminating the difference between the current reproduction points of the audio and video signals, as an extension of the currently-performed staging.

For example, in the case where the warning display includes a right arrow “->”, the operator knows that the signal under scratch reproduction is backward too much to the reverse direction from the signal under ordinary reproduction, and performs scratch reproduction toward the regular direction. In the case where the operator considers it suitable for desired staging, the operator may switch the mode to the synchronous scratch mode, to make the current reproduction points of the audio and video signals coincide with each other at once.

The system CPU 12 judges whether the difference between the current reproduction points of the audio and video signals is more than or equal to the prescribed value after an elapse of the prescribed time, for example 4 seconds, from the start of the warning display (Step S18). When the difference between the current reproduction points is less than the prescribed value owing to operator's operation (Step S18: NO), the system CPU 12 continues the asynchronous reproduction conforming to operation by the operator (Step S13).

When the difference between the current reproduction points is more than or equal to the prescribed value after the elapse of the prescribed time (Step S18: YES), the system CPU 12 forcedly synchronizes the current reproduction point of the signal under scratch reproduction with the current reproduction point of the other signal under ordinary reproduction (Step S19). After the forced synchronization, the asynchronous reproduction according to operation by the operator is repeated again (Step S13).

That is to say, if the operator leaves the state as it is even after the display of the warning, the current reproduction point of the signal under scratch reproduction is forcedly made to coincide with the current reproduction point of the signal under ordinary reproduction. As a result, in the case where the difference between the current reproduction points of the audio and video signals is larger and the reproduction of the signal under scratch reproduction may be restricted in accordance with the buffer memory capacity, it is possible to avoid deficiency of the buffer quantity certainly.

Since this forced synchronization is performed after an elapse of the prescribed time from the warning display to the operator, the operator has time to eliminate the difference between the current reproduction points, in conformity with the currently-performed staging. Forced synchronization is performed only when the difference between the current reproduction points has not been eliminated after an elapse of the prescribed time. When forced synchronization is performed, listeners of the staging feel it as a part of the staging by the operator. Thus, according to the present embodiment, the operator can perform the freest reproduction staging in asynchronous reproduction of the audio signal and the video signal within the limit of the buffer memories.

As described above, in the present embodiment, difference between the current reproduction points of the audio and video signals is monitored in the course of asynchronous reproduction of the audio and video signals. And, when the difference becomes more than or equal to the prescribed value set in conformity with the limit of the buffer memory capacities, warning is displayed to the operator. Further, when this state is not eliminated after an elapse of the prescribed time, the current reproduction time of the signal under scratch reproduction is forcedly synchronized with the current reproduction point of the signal under ordinary reproduction. Owing to this arrangement, the operator who receives the warning can eliminate the difference between the current reproduction points in conformity with the currently-performed staging. Even when the state is leaved as it is, the current reproduction points of both signals are forcedly synchronized with each other after an elapse of the prescribed time from the display of the warning, and thus the difference between the reproduction points is eliminated certainly. As a result, within the limited buffer memory capacities, the operator has the maximum freedom to perform asynchronous reproduction of the audio signal and the video signal.

The above embodiment has been described assuming that the audio buffer memory 18 and the video buffer memory 20 store an audio signal and a video signal that are extracted from a composite data stream from the reproduction part 16 and correspond to the same time code. However, the present invention can be applied to an arrangement where the audio buffer memory 18 and the video buffer memory 20 store an audio signal and a video signal that are extracted from a composite data stream from the reproduction part 16 for different ranges of time code respectively.

For example, in the example shown in FIG. 4, an audio signal and a video signal are buffered in the audio buffer memory 18 and the video buffer memory 20 by data quantities corresponding to a prescribed time period before and after the current reproduction points of those signals, respectively. As for the video signal, the buffer data are updated in conformity with ordinary reproduction, while, as for the audio signal, the buffer data are updated in conformity with scratch reproduction.

Ideally, in this arrangement, the audio signal and the video signal can be reproduced individually for any data range. Actually, however, there are technical and cost restrictions such as memory capacities. In the example shown in FIG. 4, if the asynchronous mode is switched to the synchronous mode and the current reproduction points of those signals coincide with each other when the difference between the current reproduction points of the audio and video signals exceeds 13 seconds, data corresponding to the current reproduction point of one signal has not been buffered. Thus, reading may be stopped for buffering the data in question.

The present invention can be suitably applied to avoid such a situation. That is to say, the above situation can be avoided when the system CPU 12 monitors the difference between the current reproduction points of the audio and video signals and notifies an operator of excess of the difference over a prescribed value at occurrence of such an event. Further, the current reproduction points of those signals are made to coincide after an elapse of a prescribed time from the warning.

Thus, by applying the present invention to an arrangement where data of an audio signal and a video signal are buffered for respective ranges different from each other, the audio signal and the video signal can be reproduced asynchronously at practically lower cost while ensuring the maximum freedom of staging by an operator.

Further, the above embodiment assumes that one signal is forcedly synchronized with the other signal when the difference between the current reproduction points of the audio and video signals is more than or equal to the prescribed value after elapse of the prescribed time from display of the warning. However, the difference between the current reproduction points may be reduced by a prescribed magnitude, without eliminating the difference. For example, when in this case the difference between the current reproduction points becomes more than or equal to the prescribed value, for example, 10 seconds in the above example, the current reproduction points of both signals are made to be closer to each other by a previously-determined value, for example, several seconds. This arrangement also can avoid increase of the difference between the current reproduction points.

Further, in the above embodiment, when the difference between the current reproduction points of the audio and video signals becomes more than or equal to the prescribed value, a warning is displayed for the prescribed time and thereafter the signals are reproduced synchronously. However, the signals may be synchronized immediately after the difference between the current reproduction points becomes more than or equal to the prescribed value.

Further, in the above embodiment, when the difference between the current reproduction points of the audio and video signals becomes more than or equal to the prescribed value, the signal under scratch reproduction is synchronized with the signal under ordinary reproduction. However, on the contrary, the signal under ordinary reproduction may be synchronized with the signal under scratch reproduction.

Further, the present invention can be implemented by a program for a computer apparatus, a game apparatus, or the like, such as so-called DJ software, DJ game, or the like. Such a program can be previously recorded in a storage medium (such as a CD-ROM), to be operated on a general-purpose personal computer, a game machine, or the like.

The above description gives only examples of the present invention. And, a person skilled in the art will easily understand that those illustrative embodiments can be modified in many ways without largely departing from the new disclosures and advantages of present invention. Thus, it is intended that all of such modifications is included in the scope of the present invention.

All contents of Japanese Patent Application No. 2005-291416 (filed on Oct. 4, 2005) including its description, claims, figures and abstract are hereby incorporated by reference into this application.

### INDUSTRIAL APPLICABILITY

The present invention can be applied very usefully to a reproduction apparatus that asynchronously reproduces stored audio and video signals.

What is claimed is:

1. A reproduction apparatus comprising:
a reproduction part for reproducing a stream of an audio signal and a video signal that are related to each other;
an audio buffer memory for storing the audio signal reproduced by the reproduction part, so that the stored audio signal is read from the audio buffer memory;
a video buffer memory for storing the video signal reproduced by the reproduction part, so that the stored video signal is read from the video buffer memory;
an operation detection part for detecting an input operation by an operator concerning read of the audio signal or the video signal from the audio buffer memory or the video buffer memory; and
a control part for performing control such that one of the audio signal and the video signal is read at a certain speed and in certain order from the audio buffer memory or the video buffer memory and the other signal is read at a speed and in order both corresponding to the input operation detected by the operation detection part, while the control part monitors whether difference between respective current reproduction points of the audio and video signals becomes more than or equal to a prescribed value.

2. A reproduction apparatus of claim 1, wherein:
when the difference between the current reproduction points becomes more than or equal to the prescribed value, the control part gives a warning to that effect to the operator for a prescribed time.

3. A reproduction apparatus of claim 2, wherein:
the control part makes the current reproduction points of the audio and video signals coincide with each other after an elapse of the prescribed time for the warning.

4. A reproduction method comprising:
a reproduction step, in which a stream of an audio signal and a video signal that are Page related to each other is reproduced;
an audio buffering step, in which the audio signal reproduced in the reproduction step is stored in an audio buffer memory;
a video buffering step, in which the video signal reproduced in the reproduction step is stored in a video buffer memory;
an audio read step, in which the audio signal stored in the audio buffer memory is read;
a video read step, in which the video signal stored in the video buffer memory is read;
an operation detection step, in which an input operation by an operator concerning read of the audio signal or the video signal from the audio buffer memory or the video buffer memory; and
a control step, in which one of the audio signal and the video signal is read at a certain speed and in certain order from the audio buffer memory or the video buffer memory, and the other signal is read at a speed and in order both corresponding to the input operation detected in the operation detection step, and further it is monitored whether a difference between respective current reproduction points of the audio and video signals becomes more than or equal to a prescribed value.

5. A reproduction method of claim 4, further comprising:
a step, in which when the difference between the current reproduction points becomes more than or equal to the prescribed value, a warning to that effect is given to the operator for a prescribed time.

6. A reproduction method of claim 5, further comprising:
a step, in which the current reproduction points of the audio and video signals are made to coincide with each other after an elapse of the prescribed time for the warning.

7. A computer-readable storage medium that stores a program for making a computer execute:
a reproduction procedure, in which a stream of an audio signal and a video signal that are related to each other is reproduced;
an audio buffering procedure, in which the audio signal reproduced in the reproduction procedure is stored in an audio buffer memory;
a video buffering procedure, in which the video signal reproduced in the reproduction procedure is stored in a video buffer memory;
an audio read procedure, in which the audio signal stored in the audio buffer memory is read;
a video read procedure, in which the video signal stored in the video buffer memory is read;
an operation detection procedure, in which an input operation by an operator concerning read of the audio signal or the video signal from the audio buffer memory or the video buffer memory; and
a control procedure, in which one of the audio signal and the video signal is read at a certain speed and in certain order from the audio buffer memory or the video buffer memory, and the other signal is read at a speed and in order both corresponding to the input operation detected in the operation detection procedure, and further the control procedure includes a procedure in which it is monitored whether a difference between respective current reproduction points of the audio and video signals becomes more than or equal to a prescribed value.

8. A computer-readable storage medium that stores a program according to claim 7, further comprising:
a procedure, in which when the difference between the current reproduction points becomes more than or equal to the prescribed value, a warning to that effect is given to the operator for a prescribed time.

9. A computer-readable storage medium that stores a program according to claim 8, further comprising:
a procedure, in which the current reproduction points of the audio and video signals are made to coincide with each other after an elapse of the prescribed time for the warning.

10. (canceled)
